(19) United States
(12) Patent Application Publication
(10) Pub. No.: US 2025/0317478 A1
(43) Pub. Date: Oct. 9, 2025

(54) SYSTEMS AND METHODS FOR AUTOMATICALLY SUMMARIZING ACTIONS PERFORMED ON AN ELECTRONIC DEVICE

(71) Applicant: Projector.is, Inc., San Francisco, CA (US)

(72) Inventors: Eugene ABOVSKY, Westwood, MA (US); Aleksei LOGINOV, Belmont, MA (US)

(73) Assignee: Projector.is, Inc., San Francisco, CA (US)

(21) Appl. No.: 19/008,514

(22) Filed: Jan. 2, 2025

Related U.S. Application Data
(60) Provisional application No. 63/575,833, filed on Apr. 7, 2024.

(51) Int. Cl. H04L 65/1066; G06F 9/451

(52) U.S. Cl. CPC H04L 65/1066; G06F 9/453

(57) ABSTRACT

An automated process records actions performed on a computer by an agent accessing the computer through a remote computer support system and generates a human-readable detailed description of the sequence of steps performed by the agent. The process communicates with the operating system of the remote computer to detect and record a filtered list of specific operations performed by the person operating the computer (remotely or locally), including clicks of the mouse or other pointing device, the selected input, and certain system events (such as the opening and closing of windows and applications). The filtered log data is processed using a Large Language Model into a format more analogous to natural language. The Summaries can be used to train chatbots and to provide customers with self-help resources to resolve issues using the summarized steps.

### PRIORITY CLAIM

This application claims the benefit of U.S. Provisional Patent Application Ser. No. 63/575,833, filed Apr. 7, 2024, titled “Systems and Methods for Automatically Summarizing Actions Performed on an Electronic Device,” the entire disclosure of which is incorporated herein by reference.

### INCORPORATION BY REFERENCE

The Computer Program Listing Appendix submitted herewith as an ASCII text file titled “ChangePassRawLog,txt”, created Mar. 31, 2024, having a file size of 27,415 bytes (size on disk 32,768 bytes), is hereby incorporated into this specification by reference.

### TECHNICAL FIELD

The present invention relates generally to electronic systems and methods for automatically generating a human-readable description of a sequence of steps performed by a user who is operating a mouse or other pointing and selection device to control a computer, and to useful applications for the descriptions thus generated.

### BACKGROUND ART

Commercially available remote computer support systems allow a user, such as a technical support agent, to connect to a remote computer and perform certain control functions on the remote computer.

An example of such a system is disclosed in U.S. Pat. No. 10,826,791 to Lilienthal, et al. In the system of U.S. Pat. No. 10,826,791, a technical support agent can connect to a remote computer and perform certain control functions on the remote computer. For example, the agent can take over the remote computer's mouse functions, point to a window or function, select it to cause the remote computer to activate or configure software, and perform other remotely controlled functions.

Lilienthal, et. al. discloses embodiments that include a server-based system, enabling the agent to connect in a streamlined manner with the customer's device and receive an image of the customer's desktop, screen, or application at the agent's computing device (desktop, laptop, tablet or smartphone). The remote system's screen image may be viewed through specific software or through a standard web browser (for example, Chrome, Firefox, or Edge). This system can be used to provide information technology support, and to support e-commerce, sales presentations, and other functions. With the permission of the operator of the remote system, the user can guide the operator with a pointer controlled by the agent and displayed on the user's screen. The user can also take over control of the operator's device and remotely control its functions through the remote device's operating system.

Systems of this type are widely used in industry to deliver technical support and other guidance to customers using various types of computing devices. However, the inventors have noted that conventional remote support systems do not include any mechanism for automatically analyzing and summarizing the steps performed by the agent to handle a customer request. The inventors have also determined that there is a need for improved methods of recording the steps taken to perform a particular remote service, solve a particular customer problem, or provide specific support to a customer, so that the steps followed by an agent who has provided effective support can be used as a source to train and guide other agents in providing support services, and ultimately to guide customers in solving their own problems without one-on-one assistance from an agent.

### SUMMARY OF THE DISCLOSURE

The systems and methods disclosed herein enable automated monitoring of actions performed on a computer by an agent accessing the computer (either directly or by remote connection) and automatically generate a human-readable detailed description of the sequence of steps performed by the agent.

In a preferred embodiment, these functions are performed in the context of a remote computer support system that allows an agent to connect to a remote computer and perform certain control functions on the remote computer to deliver technical support and other services. For example, in these systems an agent can take over the remote computer's mouse functions, point to a window or function and select it to cause the remote computer to activate or configure software, and perform other remotely controlled functions.

An automated process incorporating artificial intelligence capabilities captures and logs events occurring during a support session and processes this information to provide an accurate summary of the actions performed in the support session. The electronic logging process communicates with operating system functions of the remote computer, to detect and record each operation performed by the person operating the computer (remotely or locally), including clicks of the mouse or other pointing device, the selected input, and certain system events (such as the opening and closing of windows and applications).

The logged event data is filtered by event processing software, typically located in a support server, so that the log retains data only on a limited number of actions that are relevant to the goal of producing a compact natural language summary of a computer operating session. For example, in an embodiment the log is filtered to retain data on three types of actions: (1) focus shift to a window, (2) focus shift to an element, and (3) selection of an element (e,g, mouse click).

The filtered log data is then processed using a Large Language Model into a format more analogous to natural language. In this step, a software module replaces JSON or other non-human-language event description structures with a shortened, easy-to-read summary of each event.

The resulting summary can be stored and used in various ways. The agent may copy the summary to their clipboard, paste it somewhere else, send it back through an API integration to the support ticket system, save it as a work note or resolution summary, add it to a library of knowledge base articles, or save or transmit it for any other desired purpose. Storage and transmission functions to be performed may be selected manually by the agent or may be automated to occur in each case, or in cases where the summary result is deemed accurate based on established criteria, which may (for example) include asking the LLM to rate the quality and usefulness of the summary it produced, and using for a specified purpose only those summaries meeting specific criteria.

Summaries may be supplied to a database of problem resolution information, which is then used to train chatbots and improve the accuracy of knowledge bases provided to users. By continuously supplying summaries of agent-driven solutions to a chatbot knowledge base, the capacity of the chatbots to assist users in solving problems, thus deflecting an incident from agent handling to user self-help, will increase over time and produce ongoing increases in the types of problems that can be solved without an agent. This also increases the rate of deflection of support incidents toward automated resolutions and away from the use of limited agent service capacity.

### BRIEF DESCRIPTION OF THE DRAWINGS

The accompanying drawings, which are incorporated herein and form a part of the specification, illustrate various exemplary embodiments of the present invention and, together with the description, further serve to explain various principles and to enable a person skilled in the pertinent art to make and use the invention.

FIG. 1 is a block schematic diagram of an example embodiment that monitors remotely controlled computer activity and generates a detailed description of the activity.

FIG. 2 is a flow chart showing an example process for generating descriptions of computer activities.

FIG. 3 shows an example embodiment of a user interface window that displays a generated summary for an agent or user and receives input from the agent for further processing or use of the summary.

FIG. 4 is an example screen showing an automated interaction with a user wherein summaries generated using the processes disclosed herein are offered as guidance to the user for self-diagnosing and correcting a computer problem.

### BEST MODE FOR CARRYING OUT THE INVENTION

The present invention will be described in terms of one or more examples, with reference to the accompanying drawings.

The present invention will also be explained in terms of exemplary embodiments. This specification discloses one or more embodiments that incorporate the features of this invention. The disclosure herein will provide examples of embodiments, including examples from which those skilled in the art will appreciate various novel approaches and features developed by the inventors. These various novel approaches and features, as they may appear herein, may be used individually, or in combination with each other as desired.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, persons skilled in the art may implement such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors, typically distributed in a network. A machine-readable medium may include any mechanism for storing or transmitting information in a form readable by a machine (e.g. a computing device). For example, a machine-readable medium may include read only memory (ROM); random access memory (RAM); hardware memory in handheld computers, tablets, smart phones, and other portable devices; magnetic disk storage media; optical storage media; flash memory devices; electrical, optical, acoustical, or other forms of propagated signals (e.g. carrier waves, infrared signals, digital signals, analog signals, etc.), Internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

An example embodiment of the present invention provides improved electronic systems, network arrangements, and improved processing methods that enable automated monitoring of actions performed on a computer by a user accessing the computer either directly or by remote connection, and automatically generating a human-readable detailed description of the sequence of steps performed by the user.

In a first example embodiment, the present invention may be implemented as a function associated with a remote computer support system, such as the system disclosed in U.S. Pat. No. 10,826,791 to Lilienthal, et al. In the system disclosed in U.S. Pat. No. 10,826,791, a user, such as a technical support agent, can connect to a remote computer and is enabled to perform certain control functions on the remote computer. For example, the user can take over the remote computer's mouse functions, providing the user with the ability to point to a window or function and select it to cause the remote computer to activate or configure software, and perform other remotely controlled functions.

In an example embodiment, techniques for improved methods of sharing screen views and application functions with a user at another location are implemented using a server-based system. This system provides a method for conducting an electronic interaction by receiving an image of a desktop, screen, or application at a remotely located computing device (desktop, laptop, tablet or smartphone) with a streamlined connection process. The remote system's screen image may be viewed through specific software or through a standard web browser (for example, Chrome, Firefox, or Edge). This system can be used to provide information technology support, and to support e-commerce, sales presentations, and other functions. With the permission of the operator of the remote system, the user can guide the operator with a pointer controlled by the agent and displayed on the user's screen. The user can also take over control of the operator's device and remotely control its functions through the remote device's operating system. In embodiments where the concepts disclosed herein are implemented as part of a remote-control system, the operator of the remote system may be referred to as a “customer” and the user remotely controlling the system may be referred to as an “agent.”

Preferably, the agent can remotely view items displayed on a touch screen in iOS, remotely control a mouse and keyboard in MacOS and Windows devices, and remotely input touch or keyboard inputs on Android OS. In an embodiment, the customer activates a link transmitted by the agent or enters a session ID code into a web page or mobile application. The server identifies the customer's operating platform and initiates remote support for the user device. The system preferably encrypts communications between the customer device and the server, and the server and the agent browser or other software. In the example embodiment, 256-bit SSL is used. When used for technical support, in some disclosed embodiments the system generates a one-time key for the encrypted session. This method provides secure one-time access to the customer's device without compromising device security.

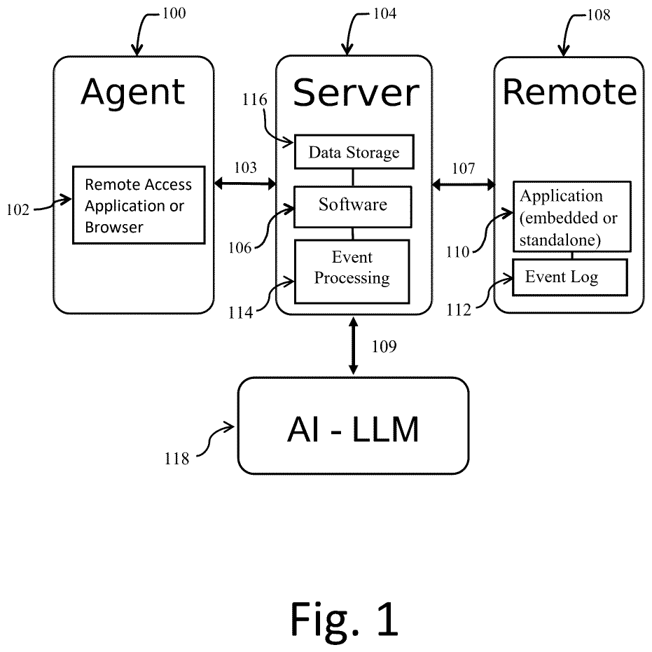

FIG. 1 is a block schematic diagram showing an implementation of an example embodiment. As shown in FIG. 1, an agent computing device 100 is supplied with a remote viewer and access application 102. Viewer application 102 can be a function-specific viewing and remote access application, or a conventional web browser (following standards in HTML5 or its successors) with appropriate standard plug-ins. For convenience viewer application 102 may be referred to herein as a “browser,” but is not limited to browsers.

A server 104 is connected via a communications network 103, such as the internet, to agent computing device 100. Customer computing device 108 is connected via a communications network 107, such as the Internet, to server 104. An artificial intelligence large language model (LLM) system 118 is connected via a communications network 109, such as the internet, to server 104.

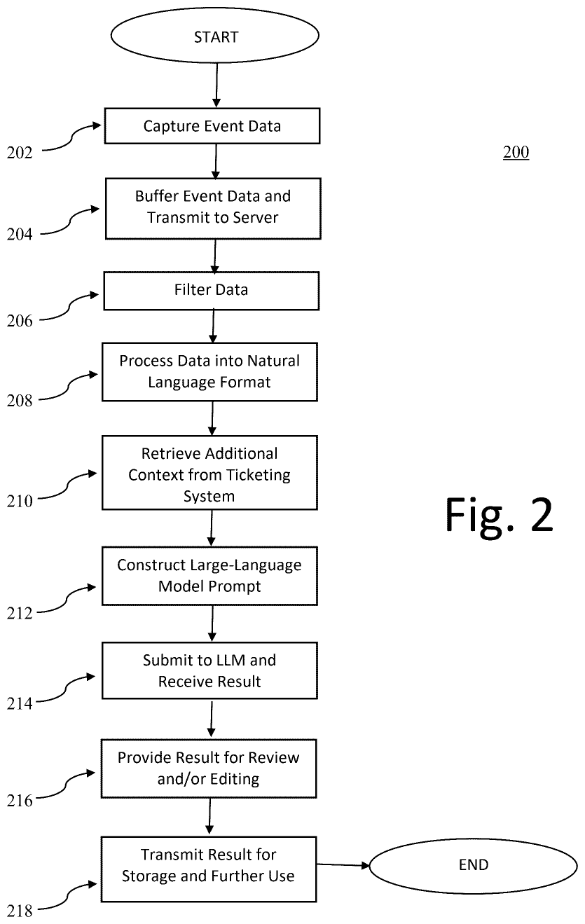

Server 104 is provided with software 106 and associated data storage 116 to perform agent account maintenance and control, transmit and receive screen displays, operating, and control information to and from a customer (or user) computing device 108. Software 106 preferably also includes event processing software that receives event data from the customer or user computing device 108, stores it in data storage 116, and processes it in a manner that will be described in more detail with reference to FIG. 2. Alternatively, the event data processing functions referenced herein may be implemented as a separate event processing software module 114 associated with software 106 in server 104. Software modules 106 and 114 may also perform other desired functions and may implement any features described or suggested herein.

Software 106 in server 104 preferably provides a function of downloading (as needed), or helping to arrange the download of, an interaction application 110 to the customer computing device 108. Interaction application 110 transmits screen displays to, and exchanges operating and control information with, server 104. The interactive application 110 preferably also incorporates event logging functions that record specific events performed by the agent on the remote device 108 and transmit event log data via network connection 107 to the server 104. These event logging functions can also be provided in a separate module 112 associated with interactive application 110.

In some embodiments, application 110 and event log software 112 are downloaded dynamically at the start of a remote-control session. In other embodiments, application 110 and software 112 are distributed to and loaded into computer 108 prior to any remote session. Application 110 and logging software 112 may, for example, be loaded on a plurality of remote computers 108 that are intended to receive technical support services from remotely located support agents, so that the agents can readily connect to computers 108 to provide support. This preloading of application 110 and logging software 112 can be performed manually or the software can be automatically distributed and preinstalled through an endpoint management system.

In some embodiments, a software development kit (SDK) is provided to developers of one or more applications for the customer computing device 108, to facilitate embedding the interaction functions described herein into an application used by the customer. In these embodiments, the desired interactions of the interactive application 110 and event logging module 112 with the software in server 104 are embedded in the developed application. In these embodiments interaction application 110 and event logging module 112 do not need to be separately installed prior to initiating an interaction session with agent computing device 100.

Communications networks 103, 107 and 109 can be the same or different networks. Each network can be any type of known network, including without limitation a local wired or wireless network, a private network, or a public network such as the Internet.

FIG. 2 is a flow chart showing the steps performed in one example embodiment of a process 200 for receiving event data generated during a remote-control session and automatically generating from that data a human-readable description of a sequence of steps performed by the agent who is remotely controlling the user or customer device. In a preferred embodiment, the event data records the clicks of a mouse or other pointing and selection device to control the user or customer computer, and software processes the event data (including processing using an LLM to generate human-readable descriptions of the steps performed by the agent during a remote session.

The process begins in step 202 with the capture of event data using software that monitors the activities of an operator of a computer. In an embodiment, the operator is an agent who is remotely accessing the computing device of a user or customer using the hardware and software configuration described above with reference to FIG. 1. The process shown in FIG. 2 will be described in terms of an implementation using the hardware and software configuration described with reference to FIG. 1. However, those skilled in the art will appreciate that other hardware and software configurations can be selected to implement this process. Further, although process 200 is being described in terms of monitoring and recording the actions of a person operating the computing device using a remote access connection, the same key process steps can be performed based on events that are generated by a local operator. That is, a similar process can be used to record the actions of a user operating the computing device directly or locally, resulting in a human-readable summary of those actions. In some embodiments, the functions described herein as being performed by a server can also be merged into software operating in the user or customer device to provide a standalone solution that will document the computer activities of the user or customer.

The event data collected in step 202 preferably includes a detailed log of each operation performed by the person operating the computer (remotely or locally). Preferably, each click of the mouse or other pointing device, each click or selection input, and certain system events (such as the opening and closing of windows and applications) is logged for this purpose. In further embodiments contemplated by the inventors, some of these categories of events may selectively be omitted from the log under predetermined circumstances, or may not be logged at all, depending on the intended use of the processed log output. In some embodiments, additional types and categories of events that can be detected within computing device 108 are also logged in the manner described herein.

In an embodiment, the event data to be logged is captured from the operating system of the computer 108, and specifically from a Human Interface/Remote Control Interface provided in the operating system of the Native Device. This information can be obtained from various commonly used operating systems, including Microsoft Windows, MacOS, Linux, Android, and others. The operating system may, in an example embodiment, provide data about a specific event in the form of a set of attributes, including an element name, element path, element accessibility label, event type (such as click, focus, etc.), application name, window name, window coordinates, event coordinates, and remote-control action or native input device action. In some embodiments the event information is provided by the operating system in the form of JSON file entries providing details of each relevant attribute for an event.

For example, in response to a left mouse button click event, logging software 112 preferably retrieves information indicating the name of the window the click occurred in, what application the window belonged to, and what element within the window it was clicked on, such as a button, with the name of the button and label of the button also logged.

In step 204, the event data is transmitted to server 104. Preferably, while logging events, the software in the system for which event data is captured will buffer the log data and periodically transmit the buffered data to the server. Buffered data may be transmitted periodically, for example every 10 or 20 seconds, or may be transmitted during periods of reduced activity. In this way, a premature end to the remote-access session or otherwise unplanned disconnection of the link between the device being logged and the server will not result in losing the entire set of log data for a particular local use or remote action session.

The server 104 has in its data storage 116, or can retrieve from other connected systems, certain event data relating to the session. Some of this event data relevant to the session may not be visible to the logging software 112 in computing device 108. For example, changes in status of the remote-control connection, start and stop times for the connection, disconnections and reconnections by the agent, recording of screenshots by the agent, and other activities occurring at the agent's end of the system may be known to the server through its service connection to the agent, but not available to computing device 108. Information of this nature that is accessible by event processing software 114 in the server and relevant to the event log is preferably combined by software 114 in server 104 with the received event data compiled by logging software 112 to obtain a more complete record of the session.

Next, in step 206, the log data received is filtered by event processing software 114 in server 104 to remove information that is deemed unnecessary for producing a compact natural language summary of a computer operating session. As noted above, the log data will typically be received in a format determined by the operating system of remote computing device 108. For example, the event log may be provided by the operating system in a raw JSON format. This format is verbose and contains information that is not a useful input to producing the desired result.

One constraint on the operation of commercially available LLMs is the context size, meaning the maximum size of the query that can be submitted. Thus, a smaller input set provides an advantage. The filtering step reduces the amount of data to be processed, reducing LLM processing costs, and makes it easier for the LLM to interpret and logically link the steps performed during the session.

An example of a raw log file in JSON format generated during a password change session conducted by a remote agent is shown in the Computer Program Listing Appendix submitted herewith as ASCII text file “ChangePassRawLog.txt”, created Mar. 31, 2024, having a file size of 27,415 bytes (size on disk 32,768 bytes), and incorporated herein by reference.

The filter algorithm is preferably adjusted and tuned depending on the operating system in use in remote computing device 108, which will determine the type and structure of the event information provided in the system's log output. For example, logged events may include moving a mouse in a path to a particular window and a subsequent click of the mouse by the user to make a selection. For this series of events, event processing software 114 may remove from the data set information specifying the path the mouse took to get to the selection. For purposes of describing steps performed by an agent or other user, whether the mouse was moved to where the click occurred directly, or in a spiral path, or was moved to overshoot the target and moved back before clicking, is not important. For many descriptive applications, the fact that the mouse was moved to a particular window and selection point and a mouse button was actuated to make a selection may be relevant, while the specific path followed by the pointer is not. In some embodiments, even the summarized movement of the mouse to a particular point may not be a useful component of the final description, and the movement information may be entirely filtered out, leaving only a statement that focus was changed to the final pointer location where the click occurred, and a record of the click event itself.

Information about mouse or other pointer “click” events can also be reduced in size and complexity during the filtering step. For example, the operating system may log as separate events a time and location where the mouse button was depressed and a time and location where the mouse button was released. When a depression and release event occur close in time and on or near the same element displayed in a window, the filter preferably combines the mouse down and mouse up event into a single “click” event. This filtering is desirable because the identity of a menu item selected by the user, and not how fast the user clicks and releases the mouse button, is more clearly relevant in describing what steps the agent or user took in a specific session.

For any given event type, the attributes received in the raw log data may be different. Some events may have no element type. A window focus change, for example, whether performed with a key combination or a pointer selection, may be worthy of recording as a minimal data point. Those skilled in the art will appreciate that, depending on the type of event and which attributes are relevant to the desired output, practical rules can be created for each event type that gather the most relevant attributes and construct them into a string of log data that is more friendly both to LLMs and human reviewers than raw output in JSON or other formats that contain a range of extraneous data. Preferably, in addition to removing information that is not needed to produce a summary of the session, the filtering process reduces “noise” in the log data, that is, information that is not relevant to the primary purpose of the session summary process.

In an example embodiment, the events captured during a session are filtered down to three types, and all other actions recorded in the raw log file are combined into one of these types or removed. The three types of events recorded in this example embodiment are (1) focus shift to a window, (2) focus shift to an element, and (3) selection of an element (e,g, mouse click).

In alternative embodiments, additional types of events and additional specific data are included in the filtered log, to the extent such additional information serves a purpose in producing a useful final summary of the particular session activity being analyzed. For example, the example embodiment does not make use of the XY coordinates of the mouse, or the dimensions of the window or element focused on by the operator, but for some embodiments adapted for deployment in specialized operating environments, such information might be a relevant part of a summary of the session activity.

Next, in step 208, the filtered log data is processed into a format more analogous to natural language. In this step, event processing software 114 replaces JSON or other non-human-language event description structures with a shortened, understandable summary of each event.

As an example, the following log file describing a password change session is generated from the “ChangePassRawLog.txt” file discussed above by the application of an example implementation of steps 206 and 208:

### FILTERED NATURAL LANGUAGE LOG FILE

2024.02.26 12:23:4.382 User focused on element “Change” from application process “SystemSettings” in window “Settings” which is a ControlType.Button located under “Window: Settings->Custom: [Unnamed]->Custom: [Unnamed]->Pane: [Unnamed]->Custom: Ways to sign in->List: [Unnamed]->ListItem: Password->Custom: Password->Button: Change”,
2024.02.26 12:22:21.827 Focus moved to a window: “” process: “explorer”,
2024.02.26 12:22:21.834 User focused on clement “Start” from application process “explorer” in window “- - - ” which is a ControlType.Button located under “Pane: [Unnamed]->Pane: [Unnamed]->Pane: [Unnamed]->Button: Start”,
2024.02.26 12:22:21.881 User focused on element “Start” from application process “explorer” in window “- - - ” which is a ControlType. Button located under “Pane: [Unnamed]->Pane: [Unnamed]->Pane: [Unnamed]->Button: Start”,
2024.02.26 12:22:21.986 Focus moved to a window: “Search” process: “SearchHost”,
2024.02.26 12:22:24.375 Focus moved to a window: “Start” process: “StartMenuExperienceHost”,
2024.02.26 12:22:24.474 Focus moved to a window: “Search” process: “SearchHost”,
2024.02.26 12:22:24.549 Focus moved to a window: “Settings” process: “ApplicationFrameHost”,
2024.02.26 12:22:25.213 User focused on element “Search box, Find a setting” from application process “SystemSettings” in window “Settings” which is a ControlType.Edit located under “Window: Settings->Custom: [Unnamed]->Edit: Search box, Find a setting”,
2024.02.26 12:22:26.364 User focused on element “screenmeet Local Account” from application process “SystemSettings” in window “Settings” which is a ControlType.Button located under “Window: [Unnamed Window]->Button: screenmeet Local Account”,
2024.02.26 12:22:33.089 User focused on element “Rewards Sign In” from application process “SystemSettings” in window “Settings” which is a ControlType.Button located under “Window: Settings->Custom: [Unnamed]->Group: [Unnamed]->Pane: [Unnamed]->Button: Rewards Sign In”,
2024.02.26 12:22:34.104 User focused on clement “Facial recognition (Windows He” from application process “SystemSettings” in window “Settings” which is a ControlType.ListItem located under “Window: Settings->Custom: [Unnamed]->Group: [Unnamed]->Pane: [Unnamed]->Group: Ways to sign in->List: [Unnamed]->ListItem: Facial recognition (Windows He”,
2024.02.26 12:22:35.758 User focused on element “Show all settings” from application process “SystemSettings” in window “Settings” which is a ControlType.Button located under “Window: Settings->Custom: [Unnamed]->Group: [Unnamed]->Pane: [Unnamed]->Group: Ways to sign in->List: [Unnamed]->ListItem: Password->Group: Password->Button: Show all settings”,
2024.02.26 12:22:38.426 User focused on element “Change” from application process “SystemSettings” in window “Settings” which is a ControlType.Button located under “Window: Settings->Custom: [Unnamed]->Group: [Unnamed]->Pane: [Unnamed]->Group: Ways to sign in->List: [Unnamed]->ListItem: Password->Group: Password->Button: Change”,
2024.02.26 12:22:38.630 User focused on element “Change your password” from application process “UserAccountBroker” in window “Change your password” which is a ControlType. Window located under “Window: Change your password”,
2024.02.26 12:22:38.644 User focused on clement “Change your password” from application process “UserAccountBroker” in window “Change your password” which is a ControlType. Window located under “Window: Change your password”,
2024.02.26 12:22:38.676 User focused on element “[Unnamed]” from application process “UserAccountBroker” in window “Change your password” which is a ControlType.Edit located under “Window: Change your password->Pane: Dialog window->Custom: Current password->Edit: [Unnamed]”,
2024.02.26 12:22:44.279 User focused on element “[Unnamed]” from application process “UserAccountBroker” in window “Change your password” which is a ControlType.Edit located under “Window: Change your password->Group: New password->Edit: [Unnamed]”,
2024.02.26 12:22:50.347 User focused on element “[Unnamed]” from application process “UserAccountBroker” in window “Change your password” which is a ControlType.Edit located under “Window: Change your password->Group: Confirm password->Edit: [Unnamed]”,
2024.02.26 12:22:58.485 User focused on element “[Unnamed]” from application process “UserAccountBroker” in window “Change your password” which is a ControlType.Edit located under “Window: Change your password->Group: Password hint->Edit: [Unnamed]”,
2024.02.26 12:23:1.288 User focused on clement “Finish” from application process “UserAccountBroker” in window “Change your password” which is a ControlType.Button located under “Window: Change your password->Button: Finish”,
2024.02.26 12:23:4.252 User focused on element “Change” from application process “SystemSettings” in window “Settings” which is a ControlType.Button located under “Window: Settings->Custom: [Unnamed]->Group: [Unnamed]->Pane: [Unnamed]->Group: Ways to sign in->List: [Unnamed]->ListItem: Password->Group: Password->Button: Change”

An event log that has been filtered in this manner to highlight the data that is more relevant to creating a summary of the session events and to convert the event descriptions to a more natural language format will be referred to herein as a Stage Two log.

In the example embodiment as described above, the raw log file is transmitted to server 104 and processed into a Stage 2 log in Server 104. However, the inventors also contemplate that the processing load for generating the Stage 2 log may be performed by either local device 108 or the server 104, or may be divided between the two processing devices in any desired manner. In some embodiments, most or all filtering is performed in computing device 108 and a Stage 2 log is transmitted to server 108 rather than a raw data log. In other useful embodiments, selected filtering functions are performed locally in device 108 before transmitting the log data to server 104, and server 104 completes the filtering and processing of the log data.

In an embodiment, filtering steps that require little processing bandwidth and can reasonably be taken at the local level to reduce the volume of event data are performed at the local level, but the resulting data is still transmitted to server 104 in a verbose format such as JSON and is translated and further filtered at the server level to produce the final Stage 2 log. For example, related mouse events such as a combined mouse click, mouse release sequence may be combined in device 108, reducing the number of JSON event entries that must be transmitted to server 104.

In step 210, event processing software 114 may optionally retrieve context information for the session that is being summarized from a support ticket system used to direct and track agent activities.

Although a technical support ticket system may be incorporated into server 104, it is common for a support ticket system to be part of a separate system, and server 104 may be connected via an API to such a support ticket management system, for example, server 104 may be connected via the internet or other communications network to support ticket services provided by SalesForce, ServiceNow, or other vendors. The API can be used to retrieve the identification of a support ticket that the session was associated with, as well as a title or short description of the support request. These or other details of the support request, if available, can be used as part of the input to the AI, grounding the LLM with the proper context and improving the performance of the summarization. Providing context regarding the intended focus of the support request improves the system's ability to filter out actions which are not relevant to the focus of the support request and its resolution.

Further filtering the events based on context provides improved results in several situations, particularly when the agent attempts several solutions before finding one that works as intended, or when the agent initiates support functions during the session that go beyond the scope of the ticket request. As one example, if the agent tries three approaches to solve a problem and the first two attempts did not work, the events involved in the unsuccessful attempts can be recognized as such and omitted from the summary of events in the session. As another example, if the agent is responding to a service ticket to change the user's password and upon accessing the remote system the agent sees a pop up that says the user's computer needs an update to the Microsoft Office suite, the agent might decide to initiate the Office software update and then proceed to change the password while the update proceeds in the background. When the context that the ticket relates to a password change is supplied to the LLM, the inventors have found that the LLM can better filter out events that are not relevant to the password change, such as activities performed in windows that are part of Microsoft Office, which would clearly be unrelated to changing the system password.

In step 212, the system described herein formulates a prompt for a large language model. The prompt is preferably constructed with context about the ticket and log data, instructing the LLM to summarize the activity and filter it for relevancy to the ticket context. Including a description of the ticket, if that information is available, will improve the accuracy and usefulness of the LLM response. However, the process can still proceed and produce useful results if that information is not available. The syntax, organization, and content of the prompt can be adjusted through reasonable experimentation to tune the results obtained. An example of an LLM prompt for the user password change session that generated the filtered natural language Stage 2 log shown above is as follows:
The issue I am helping the user with is: Change User Password
Below is a line-break delimited machine-generated log of activities I performed during our troubleshooting session. Parse the log below and generate a summary of the steps taken to resolve the user's issue that are relevant to resolving the issue. Your response should be a bullet list with 1 sentence per item.
{processed log}

The Stage 2 log (such as the example filtered and processed log shown above) is appended to the prompt where shown.

In step 214, the prompt constructed in step 212 is submitted to AI-LLM 118. LLM 118 can be chosen from among commercially available LLMs based on testing of the results achieved. As an example, the OpenAI GPT 4 produces useful results and presently does a better job of contextual filtering than some other LLMs.

The LLM processing in step 214 can be performed in a single pass. In alternative embodiments, an initial LLM query can be submitted to request a summary of everything that happened during the session. Then in a second prompt submission, the summary produced in response to the first query is submitted to the LLM with an instruction to filter out steps that are not relevant to the support ticket's stated purpose.

An example of LLM output generated from the example prompt shown above is as follows:
1. The user initiated the process by clicking the “Start” button in Windows Explorer.
2. They then used the search function, presumably to find the “Settings” application.
3. Within “Settings,” the user accessed the search box to presumably look for account or sign-in options.
4. The user navigated to their local account settings.
5. They interacted with various sign-in options including “Rewards Sign In” and “Facial recognition.”
6. The user viewed all settings related to signing in.
7. The focus shifted to changing passwords within the “Settings” app.
8. A window for changing the password (“Change your password”) was accessed.
9. The user interacted with fields for the current password, new password, confirm new password, and password hint.
10. Finally, the user clicked “Finish” to apply the password change.

The preceding process steps are preferably performed upon completion by the agent of a service session. Then, at the end of the session, in step 216, the agent is preferably provided with an automatically generated summary of the actions the agent took during the session such as the example above. The agent is preferably also presented with options for modifying and using the summary.

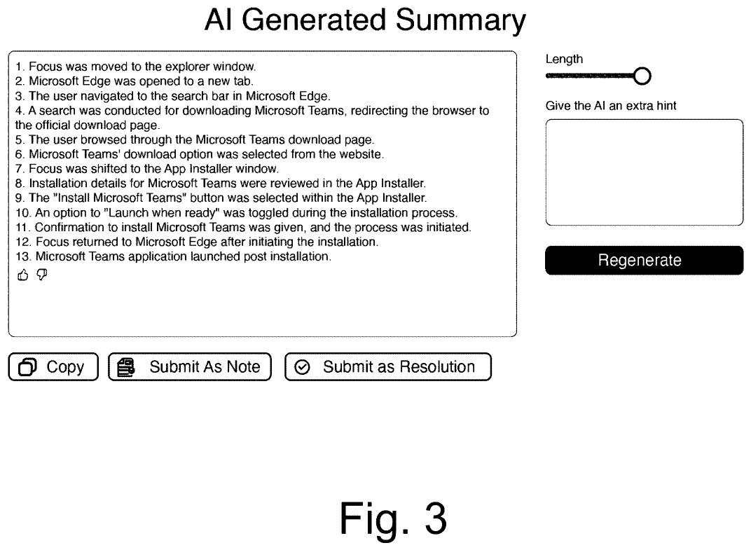

FIG. 3 shows an example embodiment of a user interface window that presents the summary in a text box, which allows the agent to manually edit the summary to correct, clarify, or delete extraneous material.

In step 218, the agent may transmit the summary (as-is or edited) for storage and further use. As examples, in this step the agent may copy the summary to their clipboard, paste it somewhere else, send it back through an API integration to the support ticket system, save it as a work note or resolution summary, add it to a library of knowledge base articles, or save or transmit it for any other desired purpose.

The storage and transmission functions to be performed may be selected manually by the agent or may be automated to occur in each case, or in cases where the summary result is deemed accurate based on established criteria, which may (for example) include asking the LLM to rate the quality and usefulness of the summary it produced and using for a specified purpose only those summaries meeting specific criteria. Agents may also be provided with options for recommending or not recommending the summary for inclusion in a knowledge base, or transmission or storage for some other purpose.

Options for storage and transmission also include generating a new or revised result to be stored or transmitted for a desired purpose. For example, the LLM can be instructed to further process the summary to shorten its length, make it verbose, or change its format. In an example embodiment, the LLM is instructed to create a three-sentence summary to provide a more compressed summary.

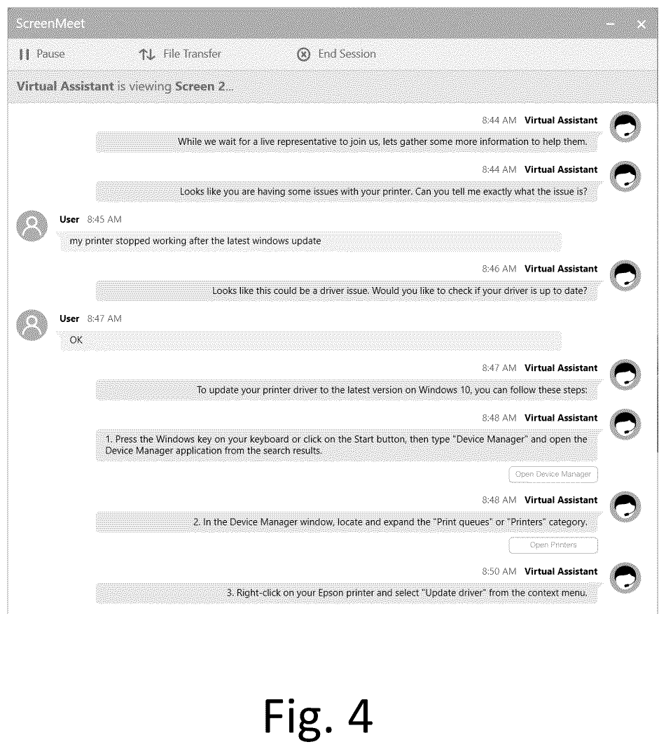

FIG. 4 is a sample screen image showing an automated text interaction with a user. In response to a user statement of a problem, the steps in a summary generated using the processes disclosed herein are offered line-by-line as guidance to the user for self-diagnosing and correcting a computer problem for which the summary is relevant. By implementing an interactive text system as shown in FIG. 4, the summaries generated by the processes disclosed herein can be used to automatically provide an alternative to initiating a support ticket and waiting for an agent to provide service. In this method for using the generated summaries, as the summaries are generated, they are supplied to a database of problem resolution information, which is then used to train chatbots and improve the accuracy of the knowledge base provided to users. By continuously supplying summaries of agent-driven solutions to a chatbot knowledge base, the capacity of the chatbots to assist users in solving problems, thus deflecting an incident from agent handling to user self-help, will increase over time and produce ongoing increases in the types of problems that can be solved without an agent. This also increases the rate of deflection of support incidents toward automated resolutions and away from the use of limited agent service capacity.

In an embodiment, the system also implements a privacy protection function wherein a list of processes (process names) identified by an administrator of the system as sensitive are not logged for AI-summarization. As an example, it may not be desirable to log processes that involve accessing or modifying private information, such as correcting an entry in a personal health record subject to the U.S. Health Insurance Portability and Accountability Act (HIPAA) or other privacy laws. During operation, when an agent activates a process, the system checks whether the process is on the blacklist. If so, the remote viewer and access application 102 preferably displays a notice to the agent that the steps performed using the process are not being recorded or summarized. Steps performed by the agent outside the blacklisted process may still be recorded, but any steps taken and data entered in the blacklisted process are not recorded and/or replicated in the log files and AI summaries.

The present invention has significant additional applications outside the field of remote support/remote control. For example, in another embodiment the same general process is used to write technical documentation for software use. As another example, in an embodiment of the invention the process disclosed above is used to create digital assistant software, that records the actions of a user and produces step-by-step documentation of what the user did. In further embodiments, the process disclosed is used to generate end-user instructions for specific tasks, instructions for technical support agents as to how to perform a specific function or solve a specific problem. The data produced in this process may also be used as an input to automated process mining, selectively made available in a database of historical solutions to user issues or made available to users or agents as part of an automatically generated knowledge-based article. Further, when a solution to a particular user issue has been confirmed as accurate and applicable, the steps of that solution recorded in the process described herein can be used as instructions for an automated support application, whether operating in the server, locally in a computing device 108, or elsewhere, that takes control of computing device 108 and sequentially performs the steps from the recorded process.

The disclosed process can also be used as an input for process mining functions performed by commercially available software, such as (for example) process mining software produced and distributed by Celonis Inc. of New York City, New York. This software assists in automating and streamlining processes to solve certain problems and improve workflows. By providing process mining software with a large-scale record of the steps that have been required to solve end user issues within a company or network, the software can identify steps and configuration modifications that can be taken to improve efficiency and reduce ongoing technical support needs.

The operation of the processes described herein, comprising event logging and generation of a human-readable summary of events occurring during a session, can be selectively activated or deactivated as desired. As a first example, these capabilities can be selectively activated or deactivated at the server 104 when providing remote access services to a company's support agents, depending on whether a subscribing company employing or supervising the support agents has contracted to receive this service option. As another example, individual agents may be provided with a selection control in remote access software 102 so that event information can be recorded in the agent's discretion or according to operational policies determining when event information should be recorded, as provided to the agent by an employer.

In further embodiments, an organization subscribing to the event logging service, or the system operator acting on behalf of that organization, can selectively exclude particular activities or applications from logging. For example, privacy concerns or laws may discourage or prohibit copying and dissemination of personal identifying information, medical records, or other categories of data. Preferably, the system includes a mechanism for entering and storing a blacklist in the system's configuration files. This blacklist identifies specific process names or applications that are not to be logged. In operation, the applicable blacklist is communicated to the client on the remotely accessed device. If an event occurs within an application that matches one of the blacklist entries, then those events will not be logged for AI-summarization.

Other examples of applications in which the disclosed process can be used include making a record of steps performed by remote control in a meeting product such as Zoom, and any other products that enable remote control of a computing device.

Although illustrative embodiments have been described herein in detail, it should be noted and understood that the descriptions and drawings have been provided for purposes of illustration only and that other variations both in form and detail can be added thereto without departing from the spirit and scope of the invention. The terms and expressions in this disclosure have been used as terms of description and not terms of limitation. Thus, the breadth and scope of the present invention should not be limited by any of the above-described exemplary embodiments but should be defined only in accordance with the claims and their equivalents. The terms and expressions herein should not be interpreted to exclude any equivalents of features shown and described, or portions thereof.

1. A process for electronically generating a human-readable description of a sequence of steps performed by an operator while remotely accessing a computing device, comprising the steps of:
a. via a network, connecting a local computing device to a remote computing device to establish a communications session wherein said operator of the local computing device can take control actions to control the operation of one or more applications in the remote computing device;
b. receiving data from said remote computing device indicating control actions performed by said operator during said session and the applications wherein such actions were taken;
c. storing a log of data indicating predetermined, selected types of said control actions and the applications wherein such actions were taken;
d. processing said log using an artificial intelligence large language model to replace non-human-language control action description structures in said log with a shortened human language summary of each control action, to produce a human-readable summary of the control actions taken by the operator in said session; and
e. storing said summary and transmitting said summary to said local computing device for review by the operator.

2. The process of claim 1 comprising the further step of providing a server connected to the local computing device and the remote computing device via said network, wherein said session is monitored by the server and said log is stored on the server.

3. The process of claim 1 wherein said predetermined types of control actions stored in said log are selected from the set comprising focus shift to a window, focus shift to an element, and selection of an element.

4. The process of claim 2 wherein steps (b) through (e) are performed in said server.

5. The process of claim 1 comprising the further step of adding said summary to a library of problem resolution information.

6. The process of claim 5 wherein said library incorporating said summary is processed to improve the accuracy of instructions provided to a user of the remote computing device.

7. The process of claim 1 comprising the further step of pre-processing said log prior to step (d) to remove data relating to logged operations that will not enhance understanding of the remote operator's activities by a reviewer of the processing output of step (d).

8. A process for electronically generating a human-readable record of steps performed by a technical support agent while accessing a user's remote computing device, comprising the steps of:
a. via a network, connecting a local computing device to a remote computing device to establish a communications session wherein said technical support agent can operate the local computing device to take control actions that remotely control the operation of one or more applications in the remote computing device;
b. receiving data from said remote computing device indicating remote control actions performed by said technical support agent while the agent has control of the remote computing device during said session, and the applications wherein such actions were taken;
c. storing a log of data indicating predetermined, selected types of said control actions and the applications wherein such actions were taken;
d. processing said log using an artificial intelligence large language model to replace non-human-language control action description structures in said log with a shortened human language summary of each control action, to produce a human-readable summary of the remote control actions taken by the technical support agent in said session; and
e. storing said summary and transmitting said summary to said local computing device for review by the technical support agent.

9. The process of claim 8 comprising the further step of pre-processing said log prior to step (d) to remove data relating to logged operations that will not enhance understanding of the remote operator's activities by a reviewer of the processing output of step (d).

10. The process of claim 8 comprising the further step of providing a server connected to the local computing device and the remote computing device via said network, wherein said session is monitored by the server and said log is stored on the server.

11. The process of claim 10 wherein steps (b) through (e) are performed in said server.

12. The process of claim 8 wherein said predetermined types of control actions stored in said log are selected from the set comprising: focus shift to a window, focus shift to an element, and selection of an element.

13. The process of claim 8 comprising the further step of adding said summary to a library of problem resolution information.

14. The process of claim 13 wherein said library incorporating said summary is processed to improve the accuracy of instructions provided to a user of the remote computing device.

15. A process for electronically generating a human-readable record of steps performed by a technical support agent while accessing a user's remote computing device, comprising the steps of:
a. via a network, connecting a local computing device to a remote computing device to establish a communications session wherein said technical support agent can operate the local computing device to take control actions that remotely control the operation of one or more applications in the remote computing device;
b. receiving data from said remote computing device indicating remote control actions performed by said technical support agent while the agent has control of the remote computing device during said session, and the applications wherein such actions were taken;
c. storing a log of data indicating predetermined, selected types of said remote control actions and the applications wherein such actions were taken, wherein the types of remote control actions logged include at least one of: focus shift to a window, focus shift to an element, and selection of an element.
d. processing said log using an artificial intelligence large language model to replace non-human-language control action description structures in said log with a shortened human language summary of each remote control action, to produce a human-readable summary of the control actions taken by the technical support agent in said session; and
e. storing said summary and transmitting said summary to said local computing device for review by the technical support agent.

16. The process of claim 15 comprising the further step of pre-processing said log prior to step (d) to remove data relating to logged operations that will not enhance understanding of the remote operator's activities by a reviewer of the processing output of step (d).

17. The process of claim 15 comprising the further step of providing a server connected to the local computing device and the remote computing device via said network, wherein said session is monitored by the server and said log is stored on the server.

18. The process of claim 17 wherein steps (b) through (e) are performed in said server.

19. The process of claim 15 comprising the further step of adding said summary to a library of problem resolution information.

20. The process of claim 19 wherein said library incorporating said summary is processed to improve the accuracy of instructions provided to a user of the remote computing device.
